(19) United States
(12) Patent Application Publication
(10) Pub. No.: US 2014/0354194 A1
(43) Pub. Date: Dec. 4, 2014

(54) MOTOR DRIVE SYSTEM

(71) Applicant: FUJI ELECTRIC CO., LTD., Kawasaki-shi (JP)

(72) Inventors: Akio TOBA, Tokyo (JP); Hidetoshi UMIDA, Tokyo (JP); Yasushi MATSUMOTO, Tokyo (JP)

(73) Assignee: FUJI ELECTRIC CO., LTD., Kawasaki-shi (JP)

(21) Appl. No.: 14/457,857

(22) Filed: Aug. 12, 2014

Related U.S. Application Data
(63) Continuation of application No. PCT/JP2012/083557, filed on Dec. 26, 2012.

(30) Foreign Application Priority Data
Mar. 12, 2012 (JP) 2012-054116

(51) Int. Cl. H02P 5/74

(52) U.S. Cl. CPC H02P 5/74
USPC 318/16

(57) ABSTRACT

There is provided a motor drive system in which an inverter integrated motor unit 200 and an upper control device 100, which controls an inverter 205 and a motor 207, are formed separated from each other. Various commands for controlling the inverter 205 and motor 207 are wirelessly transmitted to the motor unit 200 from the upper control device 100. The motor unit 200 stores information indicating an operation condition and/or operating history of the motor unit 200 and wirelessly transmits the information to the upper control device 100 in accordance with a command transmitted from the upper control device 100. By transmitting and receiving commands and data using a wireless LAN, or the like, between the upper control device 100 and the motor unit 200, the upper control device 100 can control a plurality of the motor units 200.

### CROSS-REFERENCE TO RELATED APPLICATIONS

This application is a bypass continuation application of International Application number PCT/JP2012/83557, filed on Dec. 26, 2012 and designating the United States. Furthermore, this application claims the benefit of foreign priority of Japanese application 2012-054116, filed on Mar. 12, 2012. The disclosures of these earlier applications are hereby incorporated herein by reference.

### TECHNICAL FIELD

The present invention relates to a motor drive system wherein a power converter integrated motor unit is formed by integrating a power converter, such as an inverter for a motor drive, with the motor, and wherein an upper control device controls the motor unit by wireless communication.

### BACKGROUND ART

For example, an inverter integrated motor has the advantage of being able to simplify wiring between an inverter and a motor and reduce the wiring distance. Also, in recent years, as well as a permanent magnet synchronous motor having been noticeably reduced in size, attention has been paid to a SiC (Silicon Carbide) power device as a semiconductor switching element for the inverter, and with these factors as a background, it is hoped that the inverter integrated motor will be reduced in size and increased in efficiency.

Meanwhile, there exist prior art described in PTLs 1 to 3 (identified below) wherein this kind of inverter integrated motor is controlled by wireless communication.

For example, PTL 1 discloses a technology wherein a control device integrated rotating machine is formed by integrating a control device including an inverter, a CPU, and the like, and a rotating machine such as a pump or a fan, and wireless communication is carried out between a plurality of the control device integrated rotating machines, thus enabling an additional and parallel-off operation, an alternative operation, or the like.

PTL 2 describes an inverter integrated motor configured so that the inverter integrated motor is formed by integrating an inverter device, a control circuit substrate thereof, and a motor, and operating conditions for the motor are set by wireless communication using infrared or the like from an external device.

Also, PTL 3 describes a motor drive device wherein a main circuit section 20 including a motor drive section 21, a controlled motor (brushless motor) 22, a position detection sensor section 23, a detection processing section 24, an abnormality detection section 25, a transmitter and receiver circuit 26, and an overcurrent protection section 27, and a control section 10 including a power source section 11, a control circuit 12, and a transmitter and receiver circuit 13, are formed separated from each other, thus enabling wireless communication between the transmitter and receiver circuits 13 and 26, as shown in FIG. 6.

In the main circuit section 20, 21a is an inverter circuit, 21b is a PWM circuit, 24a is a logic circuit, and 24b is a rotation detection pulse output circuit, 28 is a logic IC, while in the control section 10, 11a is an alternating current power source, 11b is a noise removal filter section, 11c is a rectifying and smoothing section which generates a drive power source of a motor 22, and 11d is a stabilized power source circuit section which generates a control power source.

In the motor drive device, the control circuit 12 carries out abnormality processing which, for example, receives a rotation detection pulse of the motor 22 transmitted from the rotation detection pulse output circuit 24b via the transmitter and receiver circuits 26 and 13, detects abnormality of the motor 22 and motor drive section 21, and transmits a signal to the abnormality detection section 25 and stops the inverter circuit 21a.

Also, the control circuit 12 detects a rotation speed from the rotation detection pulse of the motor 22 and transmits a speed command, generated in accordance with the deviation between the detected speed and a target speed, to the main circuit section 20, and the motor drive section 21 drives the motor 22 in accordance with the speed command. That is, in this heretofore known technology, wireless communication is used as signal transfer means of a speed feedback loop for controlling the rotation speed of the motor 22.

### CITATION LIST

### Patent Literature

PTL 1: JP-A-2004-360704 (Paragraphs [0018] to [0028], FIGS. 1 to 3, and the like)

PTL 2: JP-A-10-248198 (Paragraph [0025] and the like)

PTL 3: JP-A-2008-17651 (Claim 2, Paragraph [0060], FIG. 1, and the like)

### SUMMARY OF INVENTION

### Technical Problem

According to the heretofore known technology described in PTL 1, it is possible to reduce the length of wiring between the control device and the rotating machine, and complication due to the wiring is resolved by using a bus bar or the like as a wiring member. However, detection signals of a pressure sensor, temperature sensor, and the like attached to an external pipe having to be taken in the control device, wiring work therefor is necessary, and there is also the fear of disconnection in a poor peripheral environment.

Also, as the control device integrated with the rotating machine has incorporated therein the control circuit which generates various commands and operating conditions necessary for an operation of the rotating machine, the control device is easily affected by noise generated when the inverter and rotating machine are in operation. In addition, when rewriting a control program, it is necessary to exercise the rewrite by connecting to the control device a personal computer brought in an installation site of the rotating machine, and this work is cumbersome.

In the heretofore known technology described in PTL 2, as various sensors are attached to an end face portion of a motor main body, the kind of problem in PTL 1 resulting from the wiring of the sensors is resolved to some extent.

However, PTL 2 makes no special reference to the specific details of the operating conditions wirelessly transmitted from the external device to the control circuit incorporated in the inverter integrated motor.

Furthermore, in the heretofore known technology described in PTL 3, wireless communication is utilized for an exchange of not only the speed command, but the rotation speed of the motor and information for carrying out abnormality processing of the main circuit section, and normally, it is required to transmit and receive these items of information in synchronism with the calculation cycle of a microcomputer configuring the control circuit. In particular, in PTL 3, wireless is used in the speed feedback loop of the motor 22 in order to transfer a signal to the control circuit 12 from the rotation detection pulse output circuit 24b of the motor 22. In this case, when delay or defection occurs in a signal (rotation detection pulse) transmitted and received by wireless, a speed feedback system is disordered, and the action immediately becomes unstable, thus disabling a stable speed control, meaning that strict real-time properties are required of wireless communication between the transmitter and receiver circuits 26 and 13.

Herein, as a wireless communication form, a wireless LAN (Local Area Network) using a carrier wave of, for example, 2.4 [GHz] band is widely utilized for the reasons that the communication quality is stable, the system is low in cost, and the like. However, in order to use the wireless LAN as the means of communicating rotation speed information and abnormality information of which strict real-time properties are required, as in PTL 3, a dedicated protocol is needed separately, and it is very difficult to apply a so-called general-purpose wireless LAN used in a personal computer or the like.

Also, in PTL 3, as a direct current power source is supplied to the main circuit section via a power cable from the control section, the layout of the control section and main circuit section and the distance between the two are restricted, and the degree of freedom of the layout of the individual devices is low. Consequently, the heretofore known technology in PTL 3 is unfit for application, such as controlling a plurality of main circuit sections (a plurality of motors) with one control section, in a limited space in a factory or each kind of plant.

Therefore, an object of the invention is to provide a motor drive system wherein information which is comparatively low in the degree of requirement for real-time properties or of which real-time properties are not required is mutually communicated by a general-purpose wireless LAN, or the like, between an upper control device and a power converted integrated motor unit formed separated from the upper control device. In particular, an object of the invention is in that it is possible for one upper control device to wirelessly control a plurality of power converter integrated motor units as a whole.

Furthermore, another object of the invention is to provide a motor drive system wherein the fear of disconnection is reduced by lessening the burden of wiring work, and moreover, it is difficult to be affected by noise.

### Solution to Problem

In order to solve the heretofore described problems, a motor drive system of the invention includes one or a plurality of power converter integrated motor units each having a power converter for driving a motor integrated with the motor; and an upper control device, formed separated from the motor units, which controls the power converter and motor. Herein, the power converter integrated motor unit refers to a device wherein each kind of power converter for motor drive, such as an inverter or a matrix converter, is integrated with a motor.

Further, the invention is characterized in that various commands, such as an operation/stop command for controlling the power converter and motor and a forward/backward rotation command and speed command for the motor, are wirelessly transmitted to the motor unit from the upper control device.

Herein, it is desirable that the power converter integrated motor unit, including a condition monitoring device which stores information indicating an operation condition and/or operating history of the motor unit, can wirelessly transmit the information, retrieved from the condition monitoring device, to the upper control device in accordance with a command from the upper control device.

Also, it is desirable to include alarm information of the power converter integrated motor unit as the information to be stored in the condition monitoring device and transmitted to the upper control device.

Furthermore, it is good that the upper control device includes an operation management device which, based on information received from the power converter integrated motor unit, stores an operation state of the motor unit and manages the motor unit for maintenance and inspection.

It is preferable that the motor drive system of the invention is applied to a system wherein a singularity of the upper control device controls the plurality of power converter integrated motor units as a whole in a factory or each kind of plant.

It is desirable that a carrier wave of a frequency band of 30 [MHz] (in particular, 1 [GHz]) or more has only to be used, and preferably, a wireless LAN with a carrier wave of a 2.4 [GHz] band is used, for wireless transmission and reception between the upper control device and the power converter integrated motor unit.

### Advantageous Effects of Invention

The invention is such that various commands, such as an operation/stop command which determines the operation pattern of the power converter integrated motor unit and a forward/backward command, speed command, and acceleration/deceleration time command for the motor, and information, such as the operation condition and operating history of the motor unit, which is comparatively low in the degree of requirement for real-time properties or of which real-time properties are not required, are mutually transmitted and received by a general-purpose wireless LAN, or the like, between the upper control device and the power converter integrated motor unit. Because of this, it is possible to realize the drive control of one or a plurality of motor units by the upper control device at low cost under stable communication quality.

In particular, as the invention is not such as to wirelessly communicate rotation speed information, or the like, in a speed feedback loop configuring one function of the inverter, as in PTL 3, but is such as to wirelessly communicate information of which strict real-time properties are not required, it is possible to apply a general-purpose wireless LAN which does not need any special protocol, and it is possible to enjoy the advantages of the communication quality, cost, and the like of the general-purpose wireless LAN.

In addition, it is also possible to configure a power converter integrated motor unit by mounting a transmitter and receiver circuit, various control circuits, a condition monitoring device, and the like, on a substrate and integrating a power converter and a motor, and it is possible for the motor unit to come into immediate practical operation simply by connecting the motor unit to a power source and a load.

Also, as the upper control device and the power converter integrated motor unit can be disposed so as to be completely separate from each other, and there is no need for the power wire or control wire connecting the two devices, it is possible to provide a motor drive system wherein there is neither fear of disconnection nor concern of noise superimposition, and there are less restrictions on the installation site and distance.

### BRIEF DESCRIPTION OF DRAWINGS

FIG. 1 is a block diagram showing an overall configuration of a motor drive system according to an embodiment of the invention.

FIG. 2 is a block diagram showing an outline configuration of an upper control circuit in FIG. 1 together with peripheral circuit and devices.

FIG. 3 is a block diagram showing an outline configuration of a lower control circuit in FIG. 1 together with peripheral circuits and devices.

FIG. 4 is a block diagram of a main portion showing one configuration example of an inverter control circuit in FIG. 1.

FIG. 5 is an illustration of information transmitted and received between an upper control device and an inverter integrated motor unit.

FIG. 6 is a configuration diagram showing a heretofore known technology.

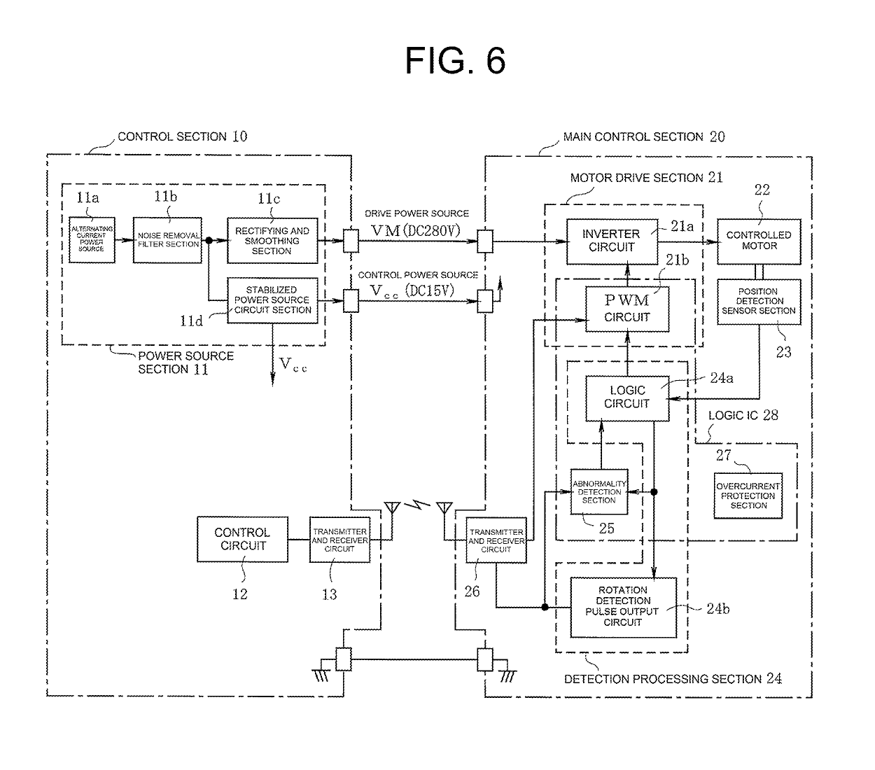

### DESCRIPTION OF EMBODIMENTS

Hereafter, a description will be given, along with the drawings, of an embodiment of the invention. In the embodiment, an inverter integrated motor unit wherein an inverter is integrated with a motor will be described as a power converter integrated motor unit, but apart from the inverter, each kind of power converter, such as a matrix converter, can be used as a power converter for motor drive.

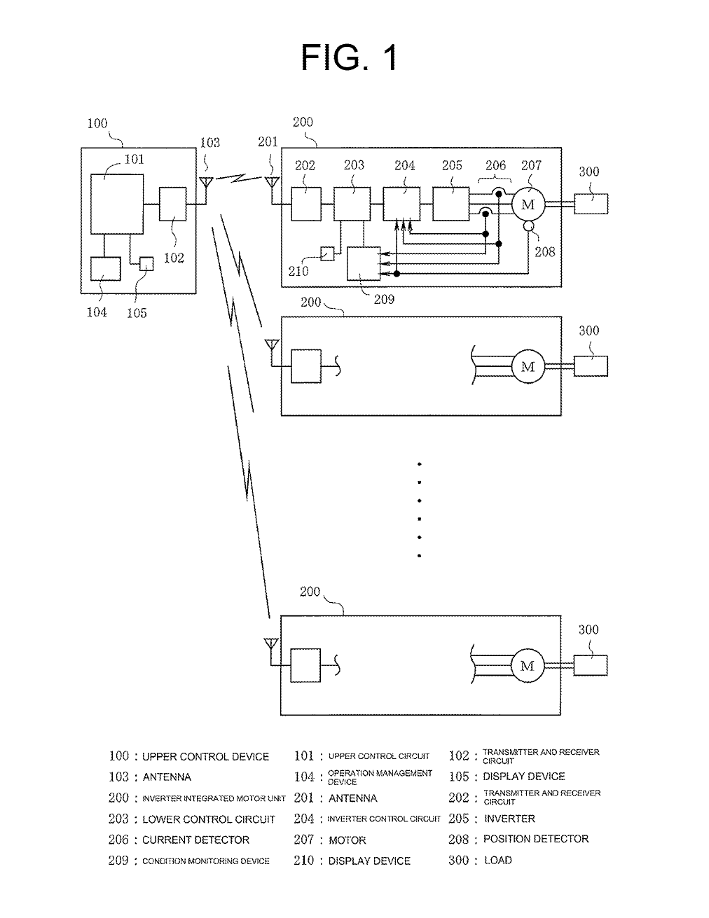

FIG. 1 is a block diagram showing an overall configuration of a motor drive system according to the embodiment. In FIG. 1, 100 is an upper control device, 200 is an inverter integrated motor unit (hereafter also referred to simply as a motor unit), and 300 is a load driven by a motor such as a permanent magnet synchronous motor.

Herein, a description will be given taking as an example a system wherein a plurality of the motor units 200 are controlled by one upper control device 100 to drive the loads 300 connected to the respective motor units 200. As will be described hereafter, when the upper control device 100 and the plurality of motor units 200 configure a wireless LAN of an infrastructure mode, the upper control device 100 acts as an access point, and the motor units 200 act as clients.

The upper control device 100 includes an upper control circuit 101, a transmitter and receiver circuit 102, an antenna 103, an operation management device 104, and a display device 105.

The upper control circuit 101, in order to control the plurality of motor units 200, has the function of generating various commands including operating conditions and the function of controlling the transmitter and receiver circuit 102, operation management device 104, and display device 105.

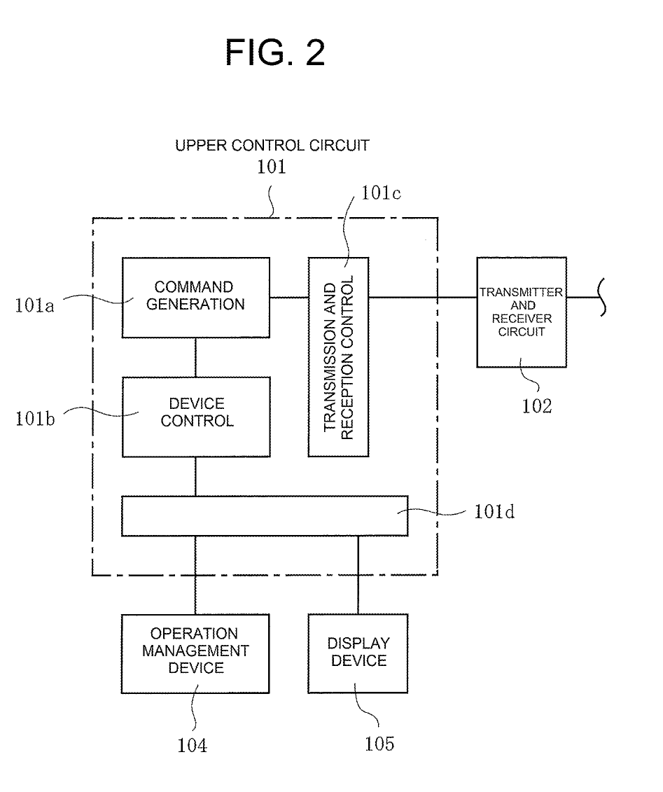

FIG. 2 is a block diagram showing an outline configuration of the upper control circuit 101 together with the peripheral circuit and devices. The upper control circuit 101 includes command generation means 101a which generates various commands (including operating conditions, as previously described) to be issued to the motor units 200, device control means 101b for controlling the action of the operation management device 104 and display device 105, transmission and reception control means 101c which controls the transmitter and receiver circuit 102, and an input/output interface 101d.

Also, the transmitter and receiver circuit 102 has the function of wirelessly transmitting and receiving various commands and data between the upper control circuit 101 and the motor units 200. The transmitter and receiver circuit 102 is a wireless communication device utilizing a carrier wave of a frequency band of, for example, 30 [MHz] (in particular, 1 [GHz]) or more, and is configured as an access point of Wireless LAN Standard “IEEE802.11b” utilizing a carrier wave of, preferably, a 2.4 [GHz] band (2.4 to 2.5 [GHz]).

The heretofore mentioned 30 [MHz] is the upper limit of the allowable frequency of conductive noise stipulated in CISPR 22 “Measurement method and tolerance of disturbance from information technology equipment” which is the standard provided by International Special Committee for Radio Interference (CISPR), and 1 [GHz] is equally the upper limit of the allowable frequency of radioactive noise. When using a frequency band of the upper limits or more for a carrier wave, it does not happen that the carrier wave has the adverse effect of noise on a peripheral device, and substantially, there is less fear of being affected by switching noise emitted by an inverter 205 to be described hereafter.

In particular, by using a wireless LAN utilizing a carrier wave of a 2.4 [GHz] band, it is possible to provide, in addition to the heretofore described working effects, hardware such as the transmitter and receiver circuit 102 and software at low cost, and in the case of a distance of, for example, on the order to 100m, it is possible to carry out stable wireless communication with the clients.

The operation management device 104 in FIG. 1 has the function of monitoring the current operation conditions (the output voltage and current values of the inverters, the temperatures of the inverters and motors, the rotation speeds of the motors, and the like) of the plurality of motor units 200 as a whole and generating an alarm as necessary, and the function of storing the operating histories of the motor units 200 and managing the motor units 200 for maintenance and inspection.

Also, the display device 105 includes a display unit on which the operation conditions and operating histories of the motor units 200 sent from the operation management device 104 by way of the upper control circuit 101 are displayed by numeral values, trend graphs, or the like, lamps, and the like.

The upper control circuit 101 and operation management device 104 shown in FIGS. 1 and 2 are each configured of a calculation processing device including a CPU (Central Processing Unit), a high-capacity storage device, and the like.

Meanwhile, the plurality of inverter integrated motor units 200, being all of the same configuration, each include a transmitter and receiver circuit 202 with an antenna 201, a lower control circuit 203, an inverter control circuit 204, the inverter 205, a current detector 206, a motor 207, a position detector 208, a condition monitoring device 209, and a display device 210. A rectified power source obtained by rectifying and smoothing, for example, the alternating current power source of the system is used as the power source of the inverter 205.

The transmitter and receiver circuit 202 has the function of acting as a client which can communicate wirelessly with the transmitter and receiver circuit 102 of the upper control device 100.

The lower control circuit 203 has a monitoring control function for sending various commands, transmitted from the upper control circuit 101, to the subsequent circuits and transmitting information stored in the condition monitoring device 209 to the upper control circuit 101 side, and the function of controlling the action of the transmitter and receiver circuit 202, condition monitoring device 209, and display device 210.

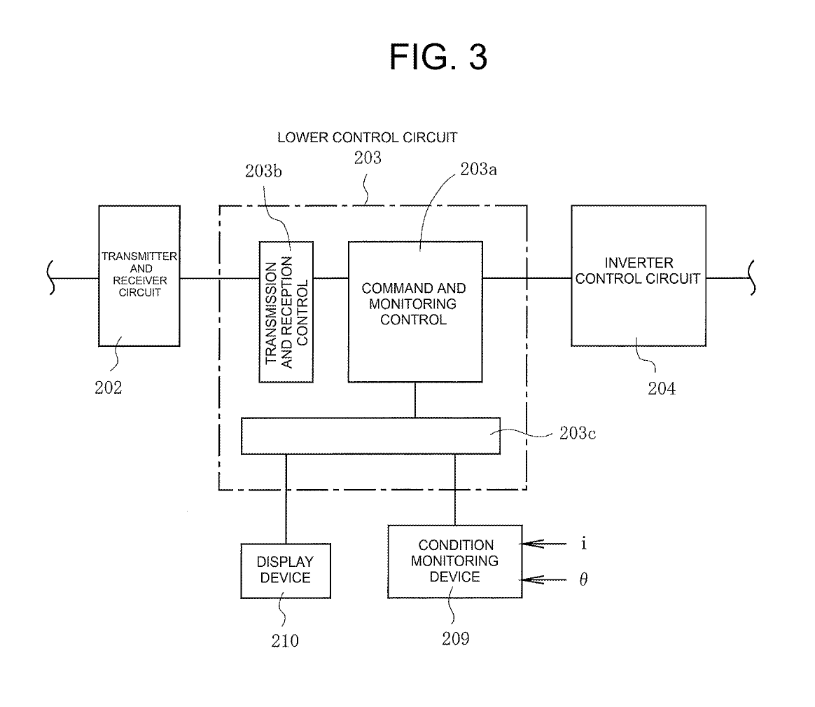

FIG. 3 is a block diagram showing an outline configuration of the lower control circuit 203 together with the peripheral circuits and devices. The lower control circuit 203 includes command and monitoring control means 203a, transmission and reception control means 203b which controls the transmitter and receiver circuit 202, and an input/output interface 203c.

The command and monitoring control means 203a carries out a series of actions for transmitting various commands received from the upper control circuit 101 to the inverter control circuit 204, monitoring the operation conditions of the inverter 205 and motor 207 in conjunction with the condition monitoring device 209, and transmitting the operation conditions and operating histories to the upper control circuit 101.

The condition monitoring device 209 has the function of monitoring the current operation conditions of the inverter 205 and motor 207, the function of generating an alarm, the function of stopping the operation of the inverter 205 when generating the alarm, and the function of storing the operating histories, and the condition monitoring items of the condition monitoring device 209 are substantially the same as the monitoring items of the operation management device 104 in the upper control device 100.

An output current (the current of the motor 207) i of the inverter 205 detected by the current detector 206 and a position of magnetic pole θ of the motor 207 detected by the position detector 208 are input into, and in addition, an output voltage (the terminal voltage of the motor 207) of the inverter 205 detected by an unshown voltage detector and temperatures of the inverter 205 and motor 207 detected by a temperature detector are input into the condition monitoring device 209.

The lower control circuit 203 and condition monitoring device 209 is also each configured of a calculation processing device including a CPU and a storage device.

In the heretofore described configuration, the position of magnetic pole of the motor 207 may be estimated from a current detection value and a speed command by a so-called position sensorless method rather than using the position detector 208.

The display device 210 displays monitoring results and operating histories from the condition monitoring device 209, an alarm, and the like, and it is only necessary to provide the display device 210 as necessary.

Upon receiving a command from the lower control circuit 203, the inverter control circuit 204 in the motor unit 200, based on information such as the previously mentioned current detection value, generates and outputs a gate pulse for driving the inverter 205.

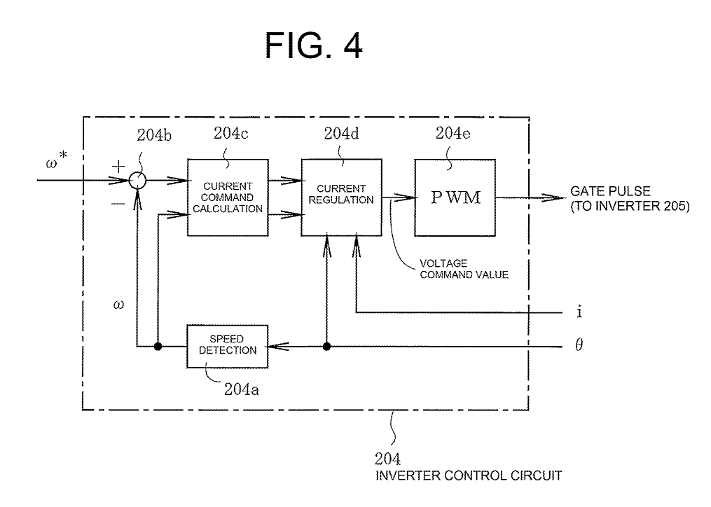

FIG. 4 is a block diagram of a main portion showing one configuration example of the inverter control circuit 204.

In FIG. 4, speed detection means 204a detects the speed of the motor 207 from the position of magnetic pole θ and outputs the speed to subtraction means 204b and current command calculation means 204c. The subtraction means 204b obtains the deviation between a speed command ω* and speed detection value ω sent from the lower control circuit 203, and the current command calculation means 204c calculates a two-axis current command value on a rotating coordinate based on the deviation and speed detection value ω, and outputs the two-axis current command value. Current regulation means 204d calculates a voltage command value based on the current command value, current detection value i, and position of magnetic pole θ, and outputs the voltage command value. PWM (Pulse Width Modulation) calculation means 204e carries out a PWM calculation based on the voltage command value, and generates and outputs a gate pulse to be given to a semiconductor switching element of the inverter 205.

As heretofore described, in the embodiment, as wireless is not used for communication means of which strict real-time properties are required for signal transfer as in the speed feedback loop of the motor 207, there is no fear that turbulence or defection occurs in a transferred signal, and it is thus possible to realize a highly responsive and stable speed feedback control.

As the form of controlling the inverter is not within the scope of the invention, the configuration of the inverter control circuit 204, not being limited to that shown in FIG. 4 in any way, may use, for example, a V/f constant control form or a sensorless vector control form.

Also, when a power converter to be integrated with the motor 207 is other than the inverter, it goes without saying that a control circuit complying with the configuration, power conversion form, and the like of the power converter is incorporated in the motor unit.

Next, a description will be given of an action of the embodiment.

Addresses are allocated to the upper control device 100 and the plurality of motor units 200, and addresses are specified, and information such as various commands and data are transmitted and received by wireless, between the upper control device 100 and each motor unit 200.

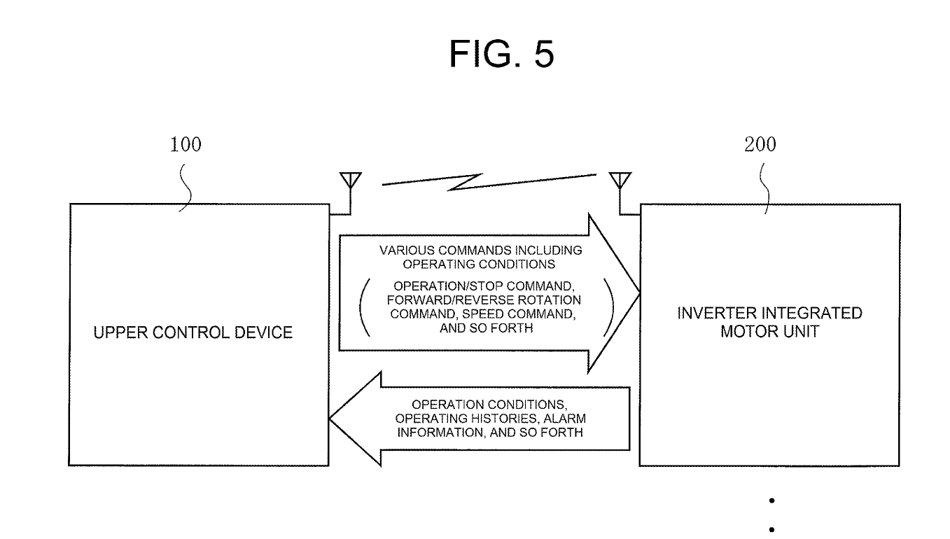

FIG. 5 is a diagram illustrating information transmitted and received between the upper control device 100 and the motor unit 200.

As shown in FIG. 5, various commands including the operating conditions of the inverter 205 and motor 207 are transmitted to each motor unit 200 from the upper control device 100, and the operation conditions, operating histories, alarm information, and the like of the inverter 205 and motor 207 are transmitted to the upper control device 100 from each motor unit 200.

Herein, as the commands transmitted to each motor unit 200 from the upper control device 100, there are an operation command and stop command for the inverter 205 and motor 207, a forward/backward rotation command, speed command (a frequency command such as a highest frequency, base frequency, or starting frequency command), acceleration/deceleration time command, and instantaneous power failure restarting command for the motor 207, a retry command for restarting the motor 207 when the inverter 205 is in a trip state, a torque boost command for regulating the output frequency-output voltage (torque) characteristics of the inverter 205 in accordance with the kind of a load (a reduced torque load or a constant torque load) and the characteristics of the motor 207, an action level command when carrying out a direct current breaking, a motor characteristic command for regulating the motor when the inverter 205 is in output current abnormality, an overheat protection command, operating history saving command and clear command, alarm history retrieval command and cancellation command, and setting data initialization command and lock command for the inverter 205 and motor 207, and the like.

Also, the operation conditions of the inverter 205 and motor 207 transmitted to the upper control device 100 from each motor unit 200 include the output voltage and current value of the inverter 205, the temperatures of the inverter 205 and motor 207, the rotation speed of the motor 207, and the like, and the operating histories include, for example, an operation time per day, an accumulated operation time, a powering and regenerative operation state, a change of the load 300 in response to the mechanical output of the motor 207, and the like. Furthermore, the alarm information includes a time at which an alarm is generated, a place in which an alarm is generated, and the number of times an alarm is generated, due to an abnormality in voltage, current, temperature, speed, or the like.

Herein, various commands transmitted to each motor unit 200 from the upper control device 100 relate mainly to an operation pattern to be given to each motor unit 200. That is, these items of information, normally being set prior to an operation of the motor unit 200, are information which are comparatively low in the degree of requirement for real-time properties, or of which real-time properties are not required, when being transmitted by wireless.

Also, information transmitted to the upper control device 100 from each motor unit 200, being mainly the current or past operation state of each motor unit 200, is not the information which should be promptly acquired and responded on the upper control device 100 side because even in the event that an alarm is generated, the response of stopping the inverter 205, or the like, can be autonomously carried out by the condition monitoring device 209 on the motor unit 200 side. That is, the information transmitted to the upper control device 100 from each motor unit 200 is also the information which is comparatively low in the degree of requirement for real-time properties or of which real-time properties are not required.

Consequently, with the system of the embodiment wherein these items of information are wirelessly communicated between the upper control device 100 and each motor unit 200, there is no effect of common mode noise either thereon compared with in the case of wire communication, and in particularly, it is possible to sufficiently enjoy wireless LAN characteristics (high quality and low cost).

Also, the need for the cumbersome work of wiring between the upper control device 100 and each motor unit 200 is eliminated in a poor installation environment in a factory, each kind of plant, or the like, thus dispelling the fear of disconnection.

As an action of the whole drive system, the previously described various commands generated by the upper control circuit 101 in the upper control device 100 are transmitted to the motor unit 200. In the motor unit 200, the inverter 205 is operated to cause the motor 207 to rotate forward or backward at a predetermined speed and in a predetermined speed pattern, in accordance with commands received via the lower control circuit 203, thus driving the load 300.

The condition monitoring device 209 constantly monitors the operation conditions of the inverter 205 and motor 207, and the condition monitoring device 209, in accordance with commands from the upper control device 100, stores the operation conditions, operating histories, and alarm information, and transmits the operation conditions, operating histories, and alarm information to the upper control device 100 via the lower control circuit 203. The display device 210 displays condition monitoring results as necessary.

In the upper control device 100, the operation management device 104 stores and manages operation states, including the operation conditions, operating histories, and alarm information, which the upper control circuit 101 has received from the motor units 200, and the display unit 105 sequentially displays the operation states.

The operation states of all the motor units 200 managed by the operation management device 104 can be made useful in, for example, comprehending the maintenance and inspection of each motor unit 200 and the power usage of the whole motor drive system.

In the embodiment, as it is not necessary to supply a direct current source to each motor unit 200, with which the upper control device 100 communicates, from the upper control device 100, as in PTL 3, it is not necessary to connect the two with a power cable. Consequently, it is advantageous in laying out devices that there is a wirelessly communicable distance because the degree of freedom of the layout of the upper control device 100 and motor units 200 in the range of the distance is higher than in PTL 3.

### INDUSTRIAL APPLICABILITY

The invention is optimum for the use of a plurality of power converter integrated motors being driven and controlled in parallel by one upper control device in, for example, a factory or each kind of plant. Also, the invention can also be utilized as a system which operates one power converter integrated motor.

### REFERENCE SIGNS LIST

100: Upper control device
101: Upper control circuit
101a: Command generation means
101b: Device control means
101c: Transmission and reception control means
101d: Input/output interface
102: Transmitter and receiver circuit
103: Antenna
104: Operation management device
105: Display device
200: Inverter integrated motor unit
201: Antenna
202: Transmitter and receiver circuit
203: Lower control circuit
203a: Command and monitoring control means
203b: Transmission and reception control means
203c: Input/output interface
204: Inverter control circuit
204a: Speed detection means
204b: Subtraction means
204c: Current command calculation means
204d: Current regulation means
204e: PWM calculation means
205: Inverter
206: Current detector
207: Motor
208: Position detector
209: Condition monitoring device
210: Display device
300: Load

1. A motor drive system, comprising:
a power converter integrated motor unit wherein a power converter for driving a motor is integrated with the motor; and
an upper control device, separated from the power converter integrated motor unit, which controls the power converter and motor,
wherein various commands for controlling the power converter and motor are wirelessly transmitted to the power converter integrated motor unit from the upper control device.

2. The motor drive system according to claim 1, wherein the power converter integrated motor unit includes a condition monitoring device which stores information indicating at least one of an operation condition and an operating history of the power converter motor unit, and retrieves the information from the condition monitoring device and transmits it to the upper control device in accordance with a command from the upper control device.

3. The motor drive system according to claim 2, wherein the power converter integrated motor unit further stores alarm information of the power converter integrated motor unit in the condition monitoring device and includes the alarm information in the information to be transmitted to the upper control device from the power converter integrated motor unit.

4. The motor drive system according to claim 3, wherein the upper control device includes an operation management device which, based on information received from the power converter integrated motor unit, stores an operation state of the power converter integrated motor unit and manages the motor unit for maintenance and inspection.

5. The motor drive system according to claim 3, further comprising at least one additional power converter integrated motor that is separated from the upper unit and controlled by the upper unit.

6. The motor drive system according to claim 4, further comprising at least one additional power converter integrated motor unit that is separated from the upper unit and controlled by the upper unit.

7. The motor drive system according to claim 1, wherein a carrier wave of a frequency band of 30 MHz or more is used for wireless transmission and reception between the upper control device and the power converter integrated motor unit.

8. The motor drive system according to claim 1, wherein a carrier wave of a frequency band of 1 GHz or more is used for wireless transmission and reception between the upper control device and the power converter integrated motor unit.

9. The motor drive system according to claim 1, wherein a wireless LAN with a carrier wave of a 2.4 GHz band is used for wireless transmission and reception between the upper control device and the power converter integrated motor unit.

10. The motor drive system according to claim 2, wherein the upper control device includes an operation management device which, based on information received from the power converter integrated motor unit, stores an operation state of the power converter integrated motor unit and manages the motor unit for maintenance and inspection.

11. The motor drive system according to claim 10, further comprising at least one additional power converter integrated motor unit that is separated from the upper unit and controlled by the upper unit.

12. The motor drive system according to claim 2, wherein a carrier wave of a frequency band of 30 MHz or more is used for wireless transmission and reception between the upper control device and the power converter integrated motor unit.

13. The motor drive system according to claim 3, wherein a carrier wave of a frequency band of 30 MHz or more is used for wireless transmission and reception between the upper control device and the power converter integrated motor unit.

14. The motor drive system according to claim 2, wherein a carrier wave of a frequency band of 1 GHz or more is used for wireless transmission and reception between the upper control device and the power converter integrated motor unit.

15. The motor drive system according to claim 14, characterized in that The motor drive system according to claim 8, wherein a wireless LAN with a carrier wave of a 2.4 GHz band is used for wireless transmission and reception between the upper control device and the power converter integrated motor unit.

16. The motor drive system according to claim 3, wherein a carrier wave of a frequency band of 1 GHz or more is used for wireless transmission and reception between the upper control device and the power converter integrated motor unit.

17. The motor drive system according to claim 16, wherein a wireless LAN with a carrier wave of a 2.4 GHz band is used for wireless transmission and reception between the upper control device and the power converter integrated motor unit.

18. The motor drive system according to claim 1, further comprising at least one additional power converter integrated motor that is separated from the upper unit and controlled by the upper unit.

19. The motor drive system according to claim 2, further comprising at least one additional power converter integrated motor that is separated from the upper unit and controlled by the upper unit.
